(19) United States
(12) Patent Application Publication
(10) Pub. No.: US 2008/0251536 A1
(43) Pub. Date: Oct. 16, 2008

(54) Bottled beverage dispenser

(76) Inventor: Kam-Lai Wong, Hong Kong (HK)

Correspondence Address: ALIX YALE & RISTAS LLP, 750 MAIN STREET, SUITE 1400, HARTFORD, CT, 06103, US

(21) Appl. No.: 11/786,689

(22) Filed: Apr. 12, 2007

(51) Int. Cl. B67D 5/62; B65D 83/00

(52) U.S. Cl. 222/146.6; 222/401; 222/400.7

(57) ABSTRACT

A bottled beverage dispenser includes a bottle receiving space for receiving a bottle having an opening to an interior containing a liquid. A fitting is sealed to the opening of the bottle. The fitting has an inlet passage and an outlet passage—each for communicating with the bottle interior. A dip tube extends from the outlet passage to a bottom portion of the bottle interior. An air pump is connected to the inlet and operates to pump air into the bottle interior above the liquid. A tap is connected inline with the dip tube and is user-activated to dispense liquid from the bottle interior.

### BACKGROUND OF THE INVENTION

The present invention relates to an apparatus for dispensing liquid beverages. More particularly, although not exclusively, the invention relates to a benchtop appliance for keeping chilled and dispensing soft drinks from plastics bottles in which the soft drinks are purchased.

Ordinarily, soft drink bottles are stored in a refrigerator and repeatedly removed from the refrigerator to pour the soft drink into glasses from which the soft drink is imbibed. This entails repeated opening and closing of a refrigerator door. As soft drink bottles are large and bulky, they also take up valuable refrigerator space.

### OBJECTS OF THE INVENTION

It is an object of the present invention to overcome or substantially ameliorate at least one of the above disadvantages and/or more generally to provide an appliance for dispensing the liquid contents of bottles on demand without inverting the bottles. It is a further object of the present invention to keep the soft drink bottles in such an appliance chilled.

### DISCLOSURE OF THE INVENTION

There is disclosed herein a bottled beverage dispenser, comprising:
a bottle receiving space for receiving a bottle having an opening to an interior containing a liquid,
a fitting for sealed attachment to the opening of a bottle placed in the bottle receiving space, the fitting having an inlet passage and an outlet passage—each for communicating with the bottle interior,
a dip tube extending from the outlet passage to a bottom portion of the bottle interior,
an air pump connected to the inlet and operative to pump air into the bottle interior, and
a tap connected inline with the dip tube and user-activated to dispense liquid from the bottle interior.

Preferably, the bottle receiving space is adapted to receive a bottle in an upright configuration.

Preferably, the pump is connected to the inlet passage by a flexible conduit.

Preferably, the tap is connected to the dip tube by a flexible conduit.

Preferably, the dip tube comprises a flexible conduit which extends to the tap.

Preferably, the tap is spaced above a drinking glass support platform.

Preferably, the dispenser further comprises a plurality of said bottle receiving spaces and a corresponding plurality of said fittings, dip tube is and taps.

Preferably, the pump is connected to each fitting via a respective flexible conduit.

Alternatively, a pair of said pumps is provided, each exclusively connected to a respective one of the fittings via a flexible conduit.

Preferably, the dispenser further comprises a refrigeration unit for cooling the bottle receiving space.

Preferably, the dispenser further comprises a fan for driving air across the refrigeration unit.

### BRIEF DESCRIPTION OF THE DRAWINGS

Preferred forms of the present invention will now be described by way of example with reference to the accompanying drawings, wherein:

FIG. 1 is a schematic front elevation of a bottled beverage dispenser with its door closed,

FIG. 2 is a schematic front elevation of the dispenser of FIG. 1 with its door open,

FIG. 3 is a schematic cross-sectional side elevation of the dispenser of FIGS. 1 and 2,

FIG. 4 is a schematic cross-sectional front elevation of the dispenser of the preceding figures,

FIG. 5 is a schematic side elevation of the dispenser of the preceding figures,

FIG. 6 is a schematic rear elevation of the dispenser of the preceding figures,

FIG. 7 is a schematic cross-sectional side elevation of another beverage dispenser, and

FIG. 8 is a schematic cross-sectional front elevation of the dispenser of FIG. 7.

### DESCRIPTION OF THE PREFERRED EMBODIMENTS

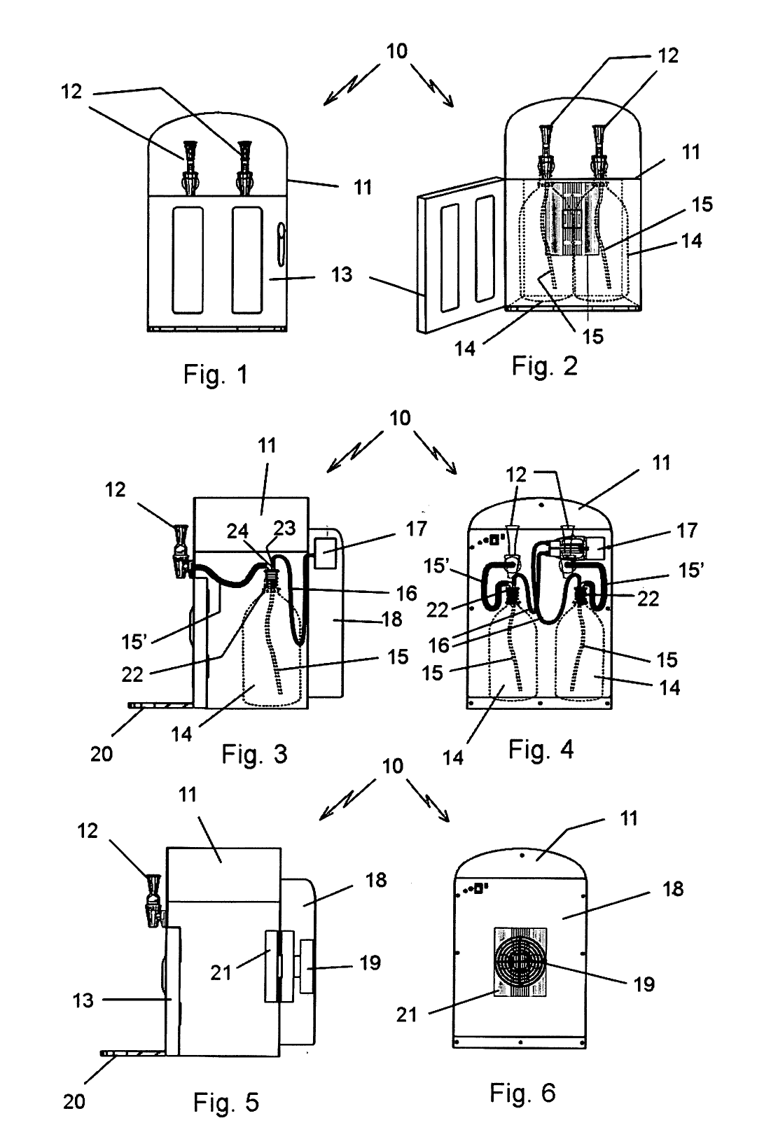

In FIGS. 1 to 6 of the accompanying drawings there is depicted schematically a bottled beverage dispenser 10 comprising a housing 11 typically made of molded plastics material. The housing has extending from its base a platform 20 upon which glasses or cups can be placed to receive soft drink dispensed via one of taps 12.

Below the taps 12 there is a door 13 which opens to reveal a bottle receiving space into which a pair of bottles 14 is placed in an upright configuration. At the back of the housing 11 there is a cover 18 inside of which there is located a refrigeration unit 21 past which a fan 19 blows air into the bottle receiving space.

For sealed fitting to the threaded opening at the neck of a standard plastics soft drink bottle 14 is an attachment 22. The exemplified embodiment houses a pair of soft drink bottles and so a pair of attachments 22 is provided. Each attachment 22 might be in the form of a press-fit stopper, or a threaded cap, or a preferably a clamp-on (non-turning) device. The fittings each have an inlet passage 23 and an outlet passage 24 extending vertically therethrough so as to communicate with the bottle interior. Each outlet passage 24 has depending from it a dip tube 15. The dip tube 15 extends to the bottom of the bottle 14 such that its distal end is immersed in the bottled liquid beverage. A flexible conduit 15′ extends from the top of the outlet passage 24 of each attachment to one of the taps 12. It should be appreciated that the cool flow of air from the refrigeration unit 21 not only cools the bottles within the bottle receiving space, but also cools the conduit 15′ through which the liquid passes, and within which a small volume of liquid would remain after a tap 12 is closed until next use, so that the first-delivered volume of liquid is cool.

Also located inside the cover 18 is an air pump 17. The single air pump 17 is connected by a pair of flexible conduits 16 to the respective inlet passage 23 of the each attachment 22. The air pump 17 is activated to apply a small positive air pressure above the liquid in each bottle, sufficient to cause a the liquid to flow adequately when a tap 22 is opened.

The appliance 10 is typically connected to a mains power socket and includes a switch for activating the pump, refrigeration unit and fan. Various lighting features might also be provided upon the appliance.

There might be provided a pressure sensor at the pump 17 to activate the pump only when pressure at the conduits 16 has fallen below a predetermined threshold. It will be appreciated here that a pressure drop in either one of the bottles will be read by the pressure sensor to activate the pump 17.

In use, a drinking glass is placed upon the platform 20 and one of taps 12 is activated to dispense a chilled soft drink into the glass. Positive air pressure above the liquid in the bottle associated with the tap that is activated causes the flow of liquid up through the dip tube 15 via the outlet passage 24 and conduit 15′ to the tap 12. As pressure above the liquid in the bottle falls, this is conveyed via conduit 16 to the pump's pressure sensor so that the pump is activated to maintain a flow of liquid at the tap 12.

When the supply of soft drink from a bottle is exhausted, the bottle can simply be replaced with a new one to which the fitting 22 can be attached. To facilitate easy identification of an empty bottle, the door 13 might be transparent or at least see-through.

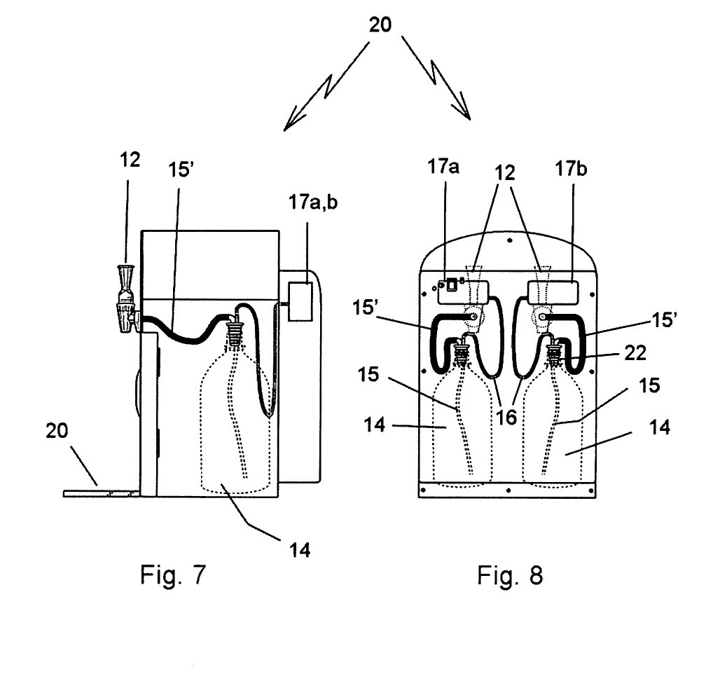

An alternative embodiment is depicted in FIGS. 7 and 8. This embodiment provides dual air pumps 17a and 17b inside the cover 18. The respective air pumps 17a and 17b are exclusively associated with just one of the bottles 14 and are connected by respective flexible conduits 16 to the respective inlet passage 23 of the each attachment 22. The pumps 17a and 17b are independently activated to apply a small positive air pressure above the liquid in just a desired one of the bottles, sufficient to cause a the liquid to flow adequately when it's tap 22 is opened. Use of this embodiment is the same as that of the embodiment of the preceding figures. A difference here is that air pumps 17a and 17b are activated only upon exclusive demand requirements of the respective bottles 14. Moreover, a pair of pressure sensors would be provided—each being associated with just one of the pumps.

It should be appreciated that modifications and alterations obvious to those skilled in the art are not to be considered as beyond the scope of the present invention. For example, the refrigeration unit and fan might have associated therewith a thermostat in thermal communication with bottles in the bottle receiving space. Furthermore, the appliance is not limited in its application to dispensing soft drinks. It could equally be used to dispense alcoholic beverages such as wine from wine bottles, and even milk from milk bottles. Also, rather than providing a tap 12 directly at each dispensing outlet, an inline valve could be provided where between the outlet passage 24 of each attachment and the dispensing outlet.

1. A bottled beverage dispenser, comprising:
a bottle receiving space for receiving a bottle having an opening to an interior containing a liquid,
a fitting for sealed attachment to the opening of a bottle placed in the bottle receiving space, the fitting having an inlet passage and an outlet passage—each for communicating with the bottle interior,
a dip tube extending from the outlet passage to a bottom portion of the bottle interior,
an air pump connected to the inlet and operative to pump air into the bottle interior, and
a tap connected inline with the dip tube and user-activated to dispense liquid from the bottle interior.

2. The dispenser of claim 1 wherein the bottle receiving space is adapted to receive a bottle in an upright configuration.

3. The dispenser of claim 1, wherein the pump is connected to the inlet passage by a flexible conduit.

4. The dispenser of claim 1, wherein the tap is connected to the dip tube by a flexible conduit.

5. The dispenser of claim 1, wherein the dip tube comprises a flexible conduit which extends to the tap.

6. The dispenser of claim 1, wherein the tap is spaced above a drinking glass support platform.

7. The dispenser of claim 1, comprising a plurality of said bottle receiving spaces and a corresponding plurality of said fittings, dip tube is and taps.

8. The dispenser of claim 7, wherein the pump is connected to each fitting via a respective flexible conduit.

9. The dispenser of claim 7, comprising a pair of said pumps, each exclusively connected to a respective one of the fittings via a flexible conduit.

10. The dispenser of claim 1, further comprising a refrigeration unit for cooling the bottle receiving space.

11. The dispenser of claim 10, further comprising a fan for driving air across the refrigeration unit.
